(19) United States
(12) Patent Application Publication
(10) Pub. No.: US 2026/0343261 A1
(43) Pub. Date: Oct. 29, 2026

(54) AGENTIC ARTIFICIAL INTELLIGENCE AND CLOUD-MANAGED CUSTOMER PREMISE EQUIPMENT FOR REGENERATING CELLULAR RADIO SIGNALS THROUGH HIGH ENERGY EFFICIENT BUILDING MATERIALS

(71) Applicants: Manoj Kumar Das, Frisco, TX (US); Dharma Teja Tummala, Allen, TX (US)

(72) Inventors: Manoj Kumar Das, Frisco, TX (US); Dharma Teja Tummala, Allen, TX (US)

(21) Appl. No.: 19/731,778

(22) Filed: Jul. 6, 2026

Related U.S. Application Data
(63) Continuation-in-part of application No. 17/921,297, filed on Apr. 26, 2021, now Pat. No. 12,684,452.
(60) Provisional application No. 63/016,185, filed on Apr. 27, 2020.

(51) Int. Cl. H04W 24/02; H04B 7/155; H04W 12/06; H04W 12/108

(52) U.S. Cl. CPC H04W 24/02; H04B 7/15507; H04W 12/06; H04W 12/108

(57) ABSTRACT

A customer premise equipment (CPE) regenerative device receives a provider specific millimeter wave wireless signal on a first side of a barrier, authenticates the signal to verify a specific wireless service provider, deconstructs the signal into a plurality of protocol stack layers of a conversion protocol, transmits the deconstructed signal across the barrier on a conduit, and regenerates the provider specific millimeter wave wireless signal on a second side of the barrier for a wireless device. An agentic AI module executing on the CPE device collects RF condition data and location data events, baselines, anomalies, and heartbeats and transmits the data to a centralized server over a management plane. The centralized server determines a reconfiguration parameter from the RF condition data, events, baselines, anomalies and heartbeats from multiple devices and external data sources and the CPE device reconfigures parameters based on the reconfiguration parameters, reducing interference among radio signals.

### CROSS-REFERENCE TO RELATED APPLICATIONS

This application is a continuation-in-part of U.S. patent application Ser. No. 17/921,297, filed on Oct. 25, 2022, which is the national stage entry of International Application No. PCT/US 2021/029517, filed on Apr. 26, 2021, which claims the benefit of U.S. Provisional Patent Application Ser. No. 63/016,185, filed on Apr. 27, 2020, each of which is incorporated in its entirety herein by reference.

### FIELD OF THE INVENTION

The present disclosure relates to wireless communication systems and, in particular, to methods and systems to enhance wireless performance within structures.

### BACKGROUND

5th Generation (5G) wireless systems represent a next major phase of mobile telecommunications standards beyond the current telecommunications standards of 4th generation (4G). In addition to faster peak Internet connection speeds, 5G planning aims at higher capacity than current 4G, allowing a higher number of mobile broadband users per area unit, and allowing consumption of higher or unlimited data quantities.

Commercial buildings as well as residential buildings often use high energy efficient materials such as window panes, window frames, and door frames that obstruct higher frequency (e.g., millimeter wave) radio signals such as 5G cellular radio waves used for voice, data, video, and text messages to 5G-capable wireless devices such as smart phones and tablets. Additionally, high frequency radio signals have high attenuation through other materials as well. Therefore, wireless service within buildings may sometimes be poor, spotty, or non-existent. Many businesses offer WiFi service to employees and guests. However, this is not always available and is often not free to visitors. Thus, methods and systems that improve cellular service within manmade structures is desirable.

### SUMMARY

In an illustrative embodiment, a method for improving wireless service within a region separated from a wireless transmission point by a barrier that obstructs or degrades a wireless signal. The method includes receiving, at a first receiver, a millimeter wave signal, wherein the millimeter wave signal is a first signal. The first signal includes a wireless transmission protocol having a stack layer. The first receiver is disposed in a first region and the first region is disposed on a first side of a barrier. The method further includes converting the millimeter wave signal to at least one of an optical signal or an electrical signal, wherein the first signal is converted from the wireless transmission protocol to a conversion protocol. The conversion protocol preserves the first signal's stack layer. The method further includes transmitting the optical signal or the electrical signal on a conduit to a second receiver, wherein the second receiver is disposed in a second region and the second region is disposed on a second side of the barrier. The method further includes converting the optical or electrical signal from the conversion protocol back to the wireless transmission protocol. The method further includes transmitting the second converted signal to a wireless device, wherein the wireless device is disposed in a third region on the second side of the barrier.

In an illustrative embodiment, a computer program product for improving wireless service within a region separated from a wireless transmission point by a barrier that obstructs or degrades a wireless signal is provided. The computer program product includes a non-transitory computer-readable storage medium, storing program codes executed by a processor, to perform receiving, at a first receiver, a millimeter wave signal, wherein the millimeter wave signal is a first signal, the first signal comprises a wireless transmission protocol having a stack layer, the first receiver is disposed in a first region, and the first region is disposed on a first side of a barrier. The program codes executed by the processor further cause the processor to perform converting the millimeter wave signal to at least one of an optical signal or an electrical signal, wherein the first signal is converted from the wireless transmission protocol to a conversion protocol, and the conversion protocol preserves the first signal's stack layer. The program codes executed by the processor further cause the processor to perform transmitting the optical signal or the electrical signal on a conduit to a second receiver, wherein the second receiver is disposed in a second region and the second region is disposed on a second side of the barrier. The program codes executed by the processor further cause the processor to perform converting the optical or electrical signal from the conversion protocol back to the wireless transmission protocol. The program codes executed by the processor further cause the processor to perform transmitting the second converted signal to a wireless device, wherein the wireless device is disposed in a third region on the second side of the barrier.

In an illustrative embodiment, a system for improving wireless service within a region separated from a wireless transmission point by a barrier that obstructs or degrades a wireless signal is provided. The system includes a first receiver configured to receive a millimeter wave signal, wherein the millimeter wave signal is a first signal, the first signal comprises a wireless transmission protocol having a stack layer, the first receiver is disposed in a first region, and he first region is disposed on a first side of a barrier. The first system further includes a first converter communicably coupled to the first receiver, the converter configured to convert the millimeter wave signal to at least one of an optical signal or an electrical signal, wherein the first signal is converted from the wireless transmission protocol to a conversion protocol and the conversion protocol preserves the first signal's stack layer. The system further includes a first transmitter coupled to the converter. The system further includes a conduit communicably coupled to the first transmitter. The system further includes a second receiver communicably coupled to the conduit, wherein the conduit is configured to transmit the optical signal or the electrical signal to the second receiver, wherein the second receiver is disposed in a second region and the second region is disposed on a second side of the barrier. The system further includes a second converter communicably coupled to the second receiver and configured to convert the optical or electrical signal from the conversion protocol back to the wireless transmission protocol. The system further includes a transmitter communicably coupled to the second converter and configured to transmit the second converted signal to a wireless device, wherein the wireless device is disposed in a third region on the second side of the barrier.

Implementations may include one or more of the following features: wherein the barrier comprises an energy absorbing material; wherein the barrier comprises an obstacle occluding line-of-sight between the wireless device and a transmitter broadcasting the millimeter wave signal to the first receiver; wherein a distance between the wireless device and the second side of the barrier is less than a distance between the wireless device and the first side of the barrier; wherein the first receiver is a first transceiver and the second receiver is a second transceiver; wherein the wireless transmission protocol comprises a 3GPP protocol stack; and wherein the conversion protocol comprises a CPRI protocol stack.

In an illustrative embodiment, a method for improving wireless service within a region separated from a wireless transmission point by a barrier that obstructs or degrades a wireless signal is provided. The method includes receiving, at a first receiver of a customer premise equipment regenerative device, a millimeter wave signal that is a first signal comprising a wireless transmission protocol having a stack layer, the first receiver disposed in a first region on a first side of the barrier; authenticating the millimeter wave signal to verify a specific wireless service provider; converting the millimeter wave signal to at least one of an optical signal or an electrical signal by deconstructing the first signal into a plurality of protocol stack layers, thereby converting the first signal from the wireless transmission protocol to a conversion protocol that preserves the stack layer of the first signal and producing a converted signal in the conversion protocol; transmitting the converted signal on a conduit to a second receiver disposed on a second side of the barrier; converting the converted signal from the conversion protocol back to the wireless transmission protocol; regenerating a provider specific millimeter wave wireless signal and transmitting the provider specific millimeter wave wireless signal to a wireless device disposed on the second side of the barrier; collecting, by an agentic artificial intelligence (AI) module executing on the customer premise equipment regenerative device, radio frequency (RF) condition data decoded by the customer premise equipment regenerative device and location data of the customer premise equipment regenerative device; transmitting, by the agentic AI module, the RF condition data and the location data and events, baselines, and heartbeats to a centralized server over a management plane; and receiving, from the centralized server in a closed feedback loop, a reconfiguration parameter determined from the RF condition data, and baseline data is prepared by the AI module locally, and reconfiguring parameters of the customer premise equipment regenerative device based on the reconfiguration parameter.

In an illustrative embodiment, a system is provided that includes a customer premise equipment regenerative device having a first receiver, authentication circuitry, a converter configured to deconstruct the first signal into a plurality of protocol stack layers, a first transmitter, a conduit crossing the barrier, a second receiver, regeneration circuitry, a second transmitter, and an agentic AI module configured to collect RF condition data and location data; and a centralized server communicably coupled to the customer premise equipment regenerative device over a management plane and configured to receive the RF condition data and the location data from the agentic AI module, determine a reconfiguration parameter from the RF condition data, events, baselines and heartbeats and transmit the reconfiguration parameter to the customer premise equipment regenerative device in a closed feedback loop to reconfigure a parameter of the customer premise equipment regenerative device.

In an illustrative embodiment, a computer program product comprising a non-transitory computer-readable storage medium storing program code executable by a processor of a customer premise equipment regenerative device is provided. The program code, when executed, performs authenticating a millimeter wave signal using at least one subscriber identity module (SIM) card, converting the first signal to a conversion protocol by deconstructing the first signal into a plurality of protocol stack layers, regenerating a provider specific millimeter wave wireless signal on a second side of the barrier, collecting RF condition data and location data events, baselines and heartbeats by an agentic AI module, transmitting the RF condition data and the location data to a centralized server over a management plane, receiving a reconfiguration parameter from the centralized server in a closed feedback loop, and reconfiguring parameters of the customer premise equipment regenerative device based on the reconfiguration parameter.

Implementations may include one or more of the following features: wherein the barrier comprises an energy absorbing material comprising at least one of a high energy efficient building material, a window pane, a window frame, or a door frame; wherein the at least one SIM card comprises a plurality of SIM cards each corresponding to a different wireless service provider; wherein the centralized server processes the RF condition data periodically in real time to select a signal having a minimum interference and a clean physical cell identity (PCI); wherein the customer premise equipment regenerative device comprises a screen and the centralized server determines location-based information from the location data for display on the screen; wherein the customer premise equipment regenerative device comprises a device management database configured to store management plane (M-Plane) data; wherein the wireless transmission protocol comprises a 3GPP protocol stack and the conversion protocol comprises a Common Public Radio Interface (CPRI) protocol stack; and wherein the RF condition data comprises at least one of a radio signal measurement, an interference measurement, or a set of available physical cell identities (PCIs).

### BRIEF DESCRIPTION OF THE DRAWINGS

Representative features of illustrative examples are set forth in the appended claims. Illustrative examples, however, as well as representatively described modes of use, further objectives, and features thereof, will best be understood by reference to the following detailed description of illustrative examples of the present disclosure when read in conjunction with accompanying drawings, wherein:

FIG. 1 is a pictorial representation of a network of data processing systems is depicted in which illustrative examples may be implemented;

FIG. 2 illustrates a network for communicating data;

FIG. 3 shows a system for regenerating high frequency radio signals inside of a building or structure in accordance with an illustrative embodiment;

FIG. 4 shows examples of a 3GPP protocol stack and a CPRI protocol stack that may be used in a representative example to convert the provider specific signal protocol to a protocol suitable for transmission via an electrical or optical physical signal propagating medium;

FIG. 5 shows a system for regenerating high frequency radio signals inside of a building or structure is depicted in accordance with an illustrative embodiment;

FIG. 6 shows a system for regenerating high frequency radio signals inside of a building or structure is depicted in accordance with an illustrative embodiment;

FIG. 7 shows a method for regenerating high frequency radio signals inside of a building or structure is depicted in accordance with an illustrative embodiment; and

FIG. 8 is a block diagram of a data processing system depicted in accordance with a representative example, whether physically localized or on the cloud.

FIG. 9 is a block diagram of a customer premise equipment regenerative device depicted in accordance with an illustrative example;

FIG. 10 is a block diagram of a system, including a customer premise equipment regenerative device and a centralized server coupled over a management plane in a closed feedback loop, depicted in accordance with an illustrative embodiment;

FIG. 11 is a block diagram of an agentic artificial intelligence (AI) module executing on a customer premise equipment regenerative device depicted in accordance with an illustrative embodiment;

FIG. 12 is a block diagram of a centralized server, or cloud compute cluster, depicted in accordance with an illustrative embodiment;

FIG. 13 is a block diagram showing a closed-loop configuration update between a customer premise equipment regenerative device and a centralized server depicted in accordance with an illustrative embodiment; and

FIG. 14 is a flowchart of a method for collecting radio frequency condition data and location data and reconfiguring a radio frequency parameter of a customer premise equipment regenerative device in a closed feedback loop depicted in accordance with an illustrative embodiment.

### DETAILED DESCRIPTION

Disclosed herein are methods, systems, and devices to regenerate radio waves inside buildings, such as residential buildings, commercial buildings, stadiums, arenas, large resorts, casinos, and the like, using modern building materials to facilitate regeneration of radio signals. Illustrative embodiments recognize and take into account that cellular wireless service providers, as well as building owners, can use the disclosed methods to augment cellular wireless service inside buildings. Illustrative embodiments also recognize and take into account that the disclosed methods will save cost of deployment of Distributed Antenna Systems (DAS). Embodiments of this disclosure are frequency specific and/or wireless service provider specific. In various embodiments, the disclosed methods regenerate one wireless service provider's or multiple wireless service providers'high frequency radio signals inside a structure, thereby mitigating effects of signal strength loss in millimeter wavelength signals resulting from barriers or line-of-sight configuration. Embodiments of the disclosure provide a solution for the current lack of 5G or millimeter wave radio signal strength inside of facilities due to high energy efficient building materials. Thus, embodiments of the disclosure provide 5G millimeter wave radio signals through high efficiency building materials.

Some or all of the above-identified technical problems can be addressed with, e.g., a signal regeneration system or method, as described herein, that includes an external transceiver, an external signal converter that converts the wireless signal from a wireless protocol to a protocol suitable for physical transmission via electrical or optical signals, a physical signal propagating material (e.g., electrical conductive cable or optical cable) connecting the external signal converter to an internal signal converter, the internal signal converter converting electrical or optical signal into the original wireless protocol, and an internal transceiver that transmits the millimeter wireless signal to a wireless device inside the structure using the original wireless protocol. The process can be reversed to transmit a millimeter wireless signal from a wireless device inside the structure to the external wireless provider.

Formation or disposition of a first feature “over” or “on” a second feature may include examples in which the first and second features are formed in direct contact, and may also include examples in which additional features may be formed between the first and second features, such that the first and second features may not be in direct contact. Spatially relative terms, such as “up,” “down,” “under,” “beneath,” “below,” “lower,” “upper,” “above,” “over,” “higher,” “adjacent,” “interadjacent,” “interposed,” “between,” or the like, may be used herein for ease of description to representatively describe one or more elements or features in relation to other elements or features as representatively illustrated in the drawings. Spatially relative terms are intended to encompass different orientations of devices or objects in use or operation, in addition to orientations illustrated in the drawings. An apparatus, device, or object may be otherwise spatially transformed-for example, rotated by 90 degrees—and the spatially relative descriptors used herein may likewise be interpreted accordingly.

Flowcharts and block diagrams in different examples may illustrate architecture, functionality, and operation of some possible implementations of apparatuses and methods in illustrative examples. In this regard, each block in flowcharts or block diagrams can represent at least one of a module, a segment, a function, or a portion of an operation or step. The illustrations are not meant to imply physical or architectural limitations to the manner in which illustrative examples may be implemented. Other components in addition to or in place of ones illustrated may be used. Some components may be unnecessary. Additionally, blocks are presented to illustrate some functional components. One or more blocks may be combined, divided, or combined and divided into different blocks when implemented in an illustrative example.

As used herein, the phrase “at least one of,” when used with a list of items, means different combinations of one or more of the listed items can be used, and only one of each item in the list may be needed. In other words, “at least one of” means any combination of items or number of items can be used from the list, but not all of the items in the list are required. The item can be a particular object, a thing, or a category. For example, without limitation, “at least one of item A, item B, or item C” may include item A, item A and item B, or item B. This example also may include item A and item B and item C, or item B and item C. Of course, any permutation or combination of these items can be present. In some illustrative examples, “at least one of” can be, for example, without limitation: two of item A, one of item B, and ten of item C; four of item B and seven of item C; or other suitable combinations.

As used herein, the terms “comprises,” “comprising,” “includes,” “including,” “has,” “having,” or any contextual variant thereof, are intended to cover a non-exclusive inclusion. For example, a process, product, composition, article, or apparatus that comprises a list of elements is not necessarily limited to only those elements, but may include other elements not expressly listed or inherent to such process, product, composition, article, or apparatus.

Furthermore, unless expressly stated to the contrary, “or” refers to an inclusive or, and not an exclusive or. That is, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless the context clearly indicates otherwise. Also, as used in the description herein, the meaning of “in” includes “in” and “on,” unless the context clearly indicates otherwise.

Although methods, steps, operations, or procedures are presented in a specific order, this order may be changed in different examples. In some examples, to the extent multiple steps are shown as sequential in the specification, drawings, or claims, some combination of such operations in other examples may be performed at a same time or in a different order. The sequence of operations described herein may be interrupted, suspended, or otherwise controlled by another process.

In some implementations of illustrative examples described herein, one or more functions noted in the blocks can occur out of the order noted in the drawings. For example, in some cases, two blocks shown in succession may be performed substantially concurrently, or the blocks may sometimes be performed in reverse order, depending on functionality involved. Also, other blocks may be added in addition to the illustrated blocks in a flowchart or block diagram. In still other examples, one or more blocks may be optionally omitted.

Examples or illustrations provided herein are not to be regarded in any way as restrictions on, limits to, or express definitions of any term or terms with which they are associated. Instead, the examples or illustrations are to be regarded as being described with respect to a particular example and as merely illustrative. Those skilled in the art will appreciate that any term or terms with which these examples or illustrations are associated will encompass other examples that may or may not be given therewith or elsewhere in the specification, and all such examples are intended to be included within the scope of that term or those terms. Language designating such non-limiting examples and illustrations includes, but is not limited to: “for example,” “for instance,” “in an example,” “in one example,” or the like. Reference throughout this specification to “one example,” “an example,” “an illustrative example,” “a particular example,” or “a specific example,” or contextually similar terminology, means that a particular feature, structure, property, or characteristic described in connection with the example is included in at least one example and may not necessarily be present in all examples. Thus, respective appearances of the phrases “in an example,” “in an illustrative example,” or “in a specific example,” or similar terminology in various places throughout the specification are not necessarily referring to the same example. Use of the term “example,” or contextual variants thereof, in no way indicates admission of prior art.

Furthermore, particular features, structures, properties, or characteristics of any specific example may be combined in any suitable manner with one or more other examples. In illustrative examples, uniform hatching, or absence of hatching, illustrated in the drawings may correspond to a substantially homogenous material. In other illustrative examples, unitary hatching, or absence of hatching, may represent one or more component material layers.

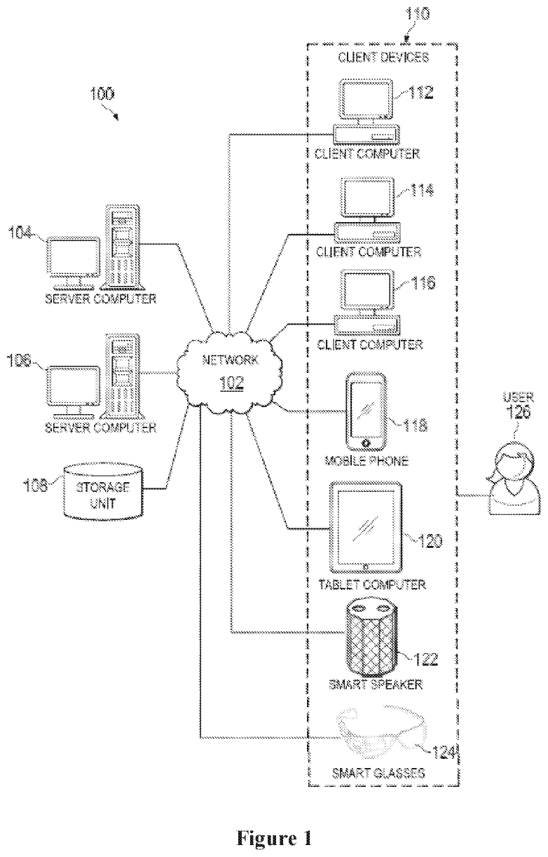

With reference now to the figures and, in particular, with reference to FIG. 1, a pictorial representation of a network of data processing systems is depicted in which illustrative examples may be implemented. Network data processing system 100 is an illustrative example of a network of physical computers in which the illustrative examples may be implemented, other possible implementations including virtual devices on the cloud or combinations of physical and virtual devices. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102, along with storage unit 108. In addition, client devices 110 connect to network 102. As depicted, client devices 110 include client computer 112, client computer 114, and client computer 116. Further, client devices 110 can also include other types of client devices such as mobile phone 118, tablet computer 120, smart speaker 122, or smart glasses 124, or the like. A user 126 may operate or interact with one or more of client devices 110. Client devices 110 can be, for example, computers, workstations, or network computers. In the depicted example, server computer 104 provides information, such as boot files, operating system images, and applications to client devices 110. Other possible implementations may include the deployment of virtual storage media and devices for the execution of coded instructions on cloud storage. In this illustrative example, server computer 104, server computer 106, storage unit 108, and client devices 110 are network devices that connect to network 102 in which network 102 is the communications media for these network devices.

Client devices 110 are clients to server computer 104 in this example. Network data processing system 100 may include additional server computers, client computers, or other devices not shown. Client devices 110 connect to network 102 utilizing at least one of wired, optical fiber, or wireless connections.

Program code located in network data processing system 100 can be stored on one or more computer-recordable physical or virtual storage media and downloaded to one or more physical or virtual data processing systems or other devices for use. For example, program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), a wide area network (WAN), a personal area network (PAN), or the like. Network 102 may be comprised of one or more Internet-of-Things (IoT) devices. FIG. 1 is intended as an example, and not as an architectural limitation for various illustrative examples.

As used herein, “a number of” when used with reference to items, means one or more items. For example, “a number of different types of networks” is one or more different types of networks.

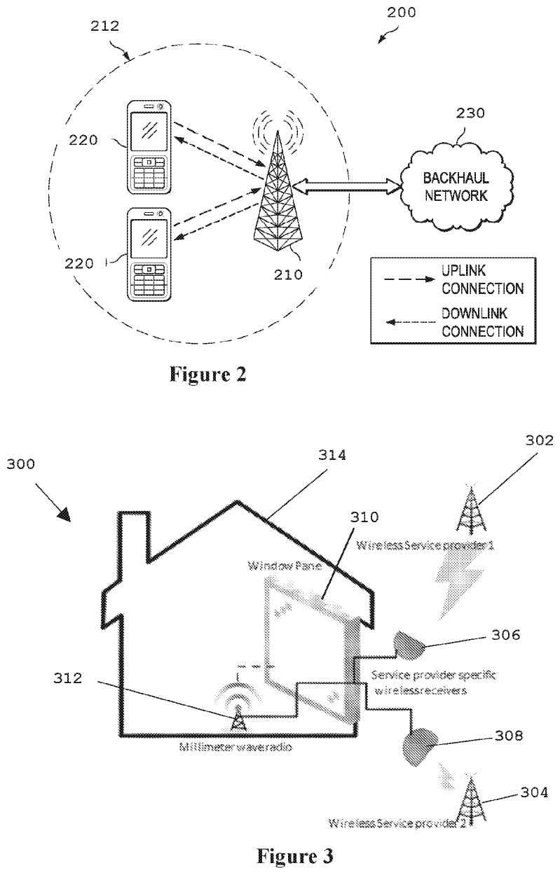

FIG. 2 illustrates a network 200 for communicating data. In a representative example, network 200 may be a 5th Generation (5G) network utilizing new radio (NR) radio access technology (RAT). Network 200 comprises an access point (AP) 110 having a coverage area 212, a plurality of user equipment (UEs) 220, and a backhaul network 230. As used herein, the term AP may also be referred to as a transmission point (TP) and the two terms may be used interchangeably throughout this disclosure. AP 210 may comprise any component capable of providing wireless access by, inter alia, establishing uplink (dashed line) or downlink (dotted line) connections with UEs 220, such as a base station transceiver (BST), an enhanced base station (eNB), a Next Generation NodeB (gNB), a femtocell, and other wirelessly enabled devices. UEs 220 may comprise any component capable of establishing a wireless connection with AP 210. Backhaul network 230 may be any component or collection of components that allow data to be exchanged between AP 210 and a remote end (not shown). In some examples, network 200 may comprise various other wireless devices, such as relays, femtocells, or the like. As shown in FIG. 2, the transmission/reception from controller to a UE is called downlink (DL) transmission/reception, and the transmission/reception from a UE to a controller is called uplink (UL) transmission/reception.

In Orthogonal Frequency-Division Multiplexing (OFDM) systems, the frequency bandwidth is divided into multiple subcarriers in frequency domain. In time domain, one subframe is divided into multiple OFDM symbols. The OFDM symbol may have a cyclic prefix to avoid inter-symbol interference due to multiple path delays. One resource element (RE) is defined by the time-frequency resource within one subcarrier and one OFDM symbol. A reference signal and other signals, such as data channel (e.g., physical downlink shared channel (PDSCH)) and control channel (e.g., physical downlink control channel (PDCCH)) are orthogonal and multiplexed in different resource elements in time-frequency domain. Further, the signals are modulated and mapped into resource elements. Using inverse Fourier transform per each OFDM symbol, the signals in frequency domain are transformed into the signals in time domain, and are transmitted with added cyclic prefix to avoid inter-symbol interference.

Turning now to FIGS. 3-6, systems for regenerating high frequency radio signals inside of a building and protocols for transmitting the signal into the building are depicted in accordance with a representative example. The systems can be implemented in, for example, network 100 or network 200.

FIG. 3 shows a system 300 for regenerating high frequency radio signals inside of a building or structure in accordance with an illustrative embodiment. System 300 may be implemented in conjunction with either of network 100 or network 200 in order to enhance and improve the wireless signal strength and data transmission within structures. System 300 includes a wireless service provider 1 TP 302 and a wireless service provider 2 TP 304. System 304 also includes one or more service provider specific wireless receivers 306, 308 located outside of a building 314. The building 314 includes a window pane 310, the window pane 310 comprising a high energy efficient building material that obstructs or degrades the millimeter wave signal, and a millimeter wave radio 312 is disposed within the building 314 and configured to regenerate the millimeter wave signal and to transmit the regenerated millimeter wave signal to one or more wireless devices located within the building 314. Additionally, the system 300 includes an external protocol converter which may be incorporated within one or both of service provider specific wireless receivers 306, 308. The service provider specific millimeter wave signal received outside the building from one of the TPs 302, 304 with one of wireless receivers 306, 308 is authenticated, amplified, and converted to a protocol suitable for transmission over a physical signal transmission media, such as an electrically conductive waveguide or optical waveguide.

In an example, the wireless protocol is converted to CPRI (Common Public Radio Interface) protocol. Alternatively, the radio signals after authentication will be reverse converted in 3GPP (3 rd Generation Partner Project) protocol stack up to the packet data convergence protocol (PDCP) layer. The converted signal is transmitted into the inside of the building where it is decoded. The original provider specific protocol is recreated, and a millimeter wave wireless signal is generated and transmitted to a wireless device inside of the building by an internal transceiver. In other words, once either of the CPRI or PDCP signals reaches inside the building, it will be connected to the 5G signal generator (e.g., the internal millimeter wave wireless signal transceiver). The 5G mm wave signal generators are wireless service provider specific; they will ingest CPRI or PDCP signals and regenerate service provider specific 5G mm wave signals inside the building. When the wireless devices and users receive the wireless signal, they will be able to decode the PSS (Primary Synchronization Signal), SSS (Secondary Synchronization Signal), eCGI (Evolved Cell Global Identity), PCI (Physical Cell Identity), RSI (Root Sequence Index), and will be successfully authenticated by the 5G MM wave radio network, and successfully provided voice, data, video or Internet of Things (IoT) communication. The external transceiver and internal transceiver can be connected by a physical signal propagating medium, such as an electrical wire or an optical fiber. The wireless signal is converted into an electrical or optical signal and transmitted via the physical wire or fiber from the outside receiver to the inside receiver.

The indoor wireless transceiver can also receive signals from wireless devices located within the building and convert the signals into a protocol suitable for transmission via an electrical or optical signal using a physical transmission medium to the external transceiver, which then converts the signal back into the original service provider specific millimeter wave (e.g., 5G) signal and transmits wireless back to the wireless service provider transmission point (e.g., a gNB).

In a representative example, the service provider specific wireless receiver is not necessarily an external device, as shown in the diagram in FIG. 3. In a representative example, a metal strip on each side of a windowpane is concealed behind the window or door frame can be used as an antenna. In an illustrative embodiment, the metal strip on the outside of the building receives all of the signals from the wireless service providers and sends the received signals to the external receiver. The external receiver is programmed with a SIM card or other mechanism to only decode, for example, 5G mm wave signals for a specific wireless service provider or for multiple wireless service providers.

In an illustrative embodiment, an impedance matching circuit is used to match the input impedance of the receiving device before connecting to the receiving device. The metal strip can have any impedance but, in an illustrative embodiment, the impedance matching device only matches the impedance of mm waves to receive (and transmit) only the mm wave signal and reject all other radio signals. As mentioned above, that mm wave signal can be from several mm wave wireless service providers, the external receiver only decodes the signal of one or multiple service providers (i.e., the one or more service providers for which it is configured to work with) to further break down to CPRI or PDCP.

In a representative example, the receiving device may not be visible. For example, in a representative embodiment, the receiving device is placed behind a false ceiling. In an illustrative embodiment, the receiving device is connected to an electrical energy source. In a representative aspect, the mm wave radio inside the building is connected to the metal strip inside of the windowpane with proper impedance matching, and the metal strip can be used as a transmitting antenna. In an illustrative embodiment, the inside metal strip is used as an antenna to transmit the regenerated signals inside the building for the wireless devices inside the building and also receive signals from the wireless devices inside the building. The outside metal strip will receive the signal coming from the towers of the wireless service providers and, in an illustrative embodiment, also transmits the signal coming from the indoor mobile devices towards the 5G mm wave towers.

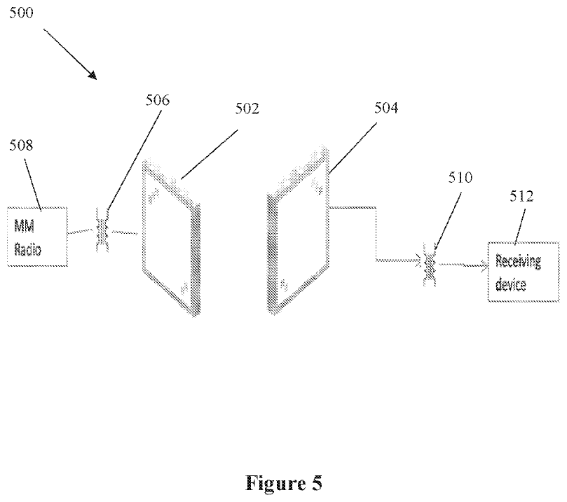

Turning now to FIG. 5 a system 500 for regenerating high frequency radio signals inside of a building or structure is depicted in accordance with an illustrative embodiment. System 500 includes metal plates 502, 504 that may be, for example, the metal frame surrounding a window, wherein metal plate 502 is an outside metal frame and metal plate 504 is an inside metal frame. System 500 also includes a millimeter (mm) wave radio 508and an impedance matching device 506 matching the impedance of the metal plate 502 to the MM radio 508. System 500 also includes an impedance matching device 510 to match the impedance of the receiving device 512 inside the structure with the metal plate 504.

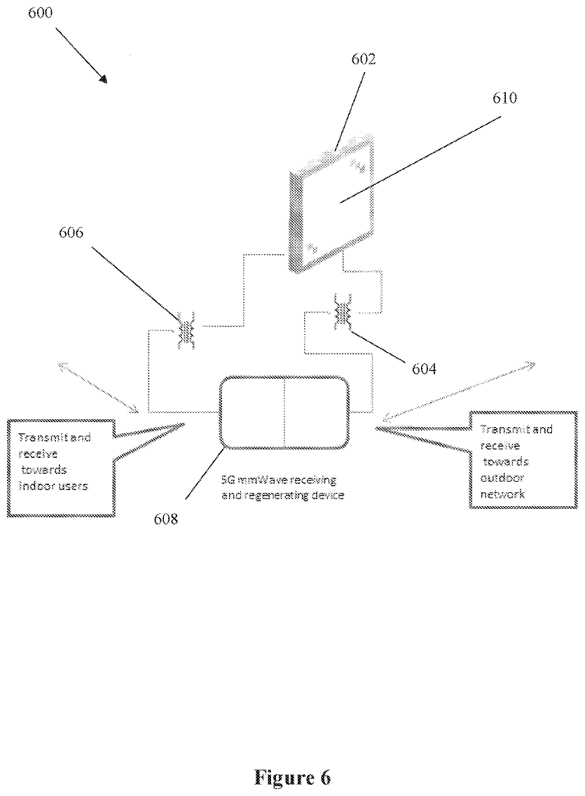

Turning now to FIG. 6 a system 600 for regenerating high frequency radio signals inside of a building or structure is depicted in accordance with an illustrative embodiment. System 600 includes a barrier 610 such as, for example, a window, surrounded by a metal plate 602. System 600 also includes impedance matching devices 606, 604 to match the impedance of the metal plates 602, 610 with the receivers in device 608. In an illustrative embodiment, rather than having separate devices inside and outside the building, a single device 608, as shown in FIG. 6, receives the 5G signals from the wireless service provider tower via, for example, the outer wire frame of a window functioning as an antenna or an antenna located external to the building. The signal is then regenerated by an indoor transceiver and transmitted to wireless devices located within the building through using the inside metal frame of the window functioning as an antenna for transmitting and receiving 5G signals within the building. The 5G signals from the wireless devices inside the building are received by the inside metal frame of the window which is functioning as an antenna and received by the 5G mm wave receiving and regenerating device, which then regenerates the 5G signal and transmits it through the external antenna (e.g., the outside metal frame of the window or a physically distinct antenna located outside the building) to the 5G wireless service provider.

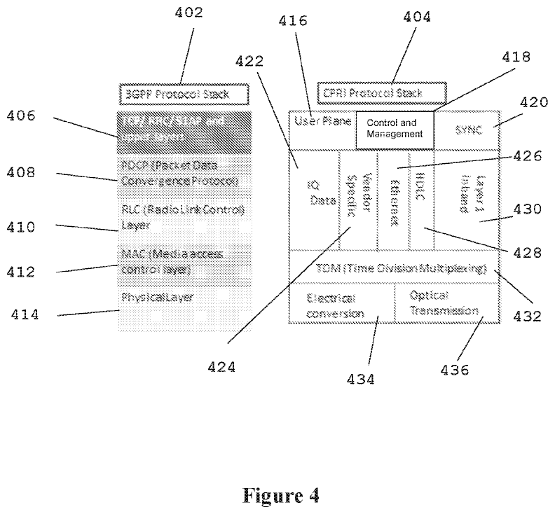

FIG. 4 shows examples of a 3GPP protocol stack 402 and a Common Public Radio Interface (CPRI) protocol stack 404 that may be used in a representative example to convert the provider specific signal protocol to a protocol suitable for transmission via an electrical or optical physical signal propagating medium. 3GPP protocol stack 402 is an example of a provider specific signal protocol. 3GPP protocol stack 402 includes a transmission control protocol (TCP)/radio resource control (RRC)/S1 Application Protocol (S1AP) and upper layers 406, a packet data convergence protocol (PDCP) layer 408, a radio link control (RLC) layer 410, a Media access control layer (MAC) 412 and a physical layer 414. CPRI protocol stack 404 includes a user plane 416, control and management 418, a SYNC 420, IQ data 422, vendor specific layer 424, ethernet layer 426, HDLC layer 428, layer 1 inband 430, Time division multiplexing (TDM) 432, electrical conversion layer 434, and optical transmission layer 436. In illustrative embodiments, the systems disclosed herein convert the 3GPP protocol stack into a CPRI protocol stack for transmitting the received wireless signal across a barrier via an electrical or optical conduit.

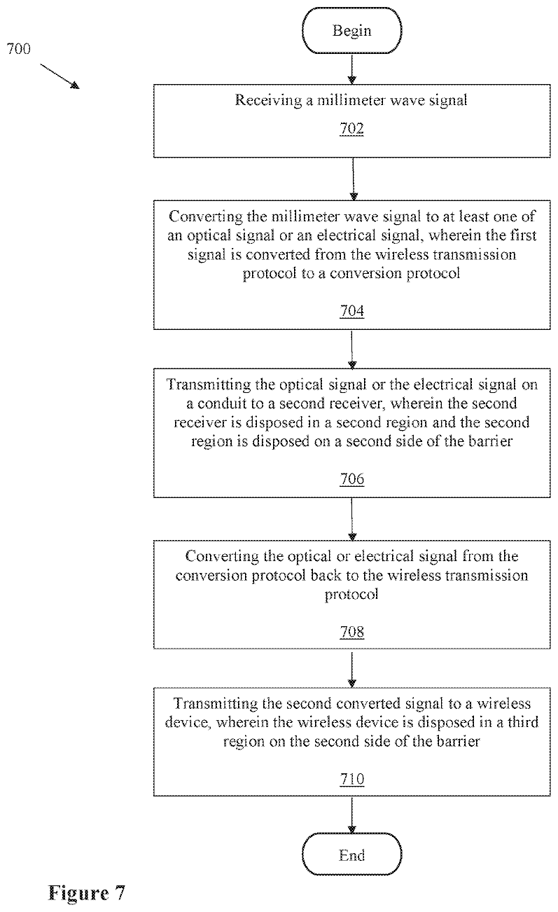

FIG. 7 shows a flowchart of an exemplary method 700 for improving transmission of wireless signals across a barrier depicted in accordance with an illustrative embodiment. The method begins at block 702 where a first receiver receives a millimeter wave signal, wherein the millimeter wave signal is a first signal. The first signal includes a wireless transmission protocol having a stack layer. The first receiver is disposed in a first region and the first region is disposed on a first side of a barrier. The method 700 further includes at block 704 converting the millimeter wave signal to at least one of an optical signal or an electrical signal, wherein the first signal is converted from the wireless transmission protocol to a conversion protocol. The conversion protocol preserves the first signal's stack layer. The method 700 further includes at block 706 transmitting the optical signal or the electrical signal on a conduit to a second receiver, wherein the second receiver is disposed in a second region and the second region is disposed on a second side of the barrier. The method 700 further includes at block 708 converting the optical or electrical signal from the conversion protocol back to the wireless transmission protocol. The method 700 further includes at block 710 transmitting the second converted signal to a wireless device, wherein the wireless device is disposed in a third region on the second side of the barrier.

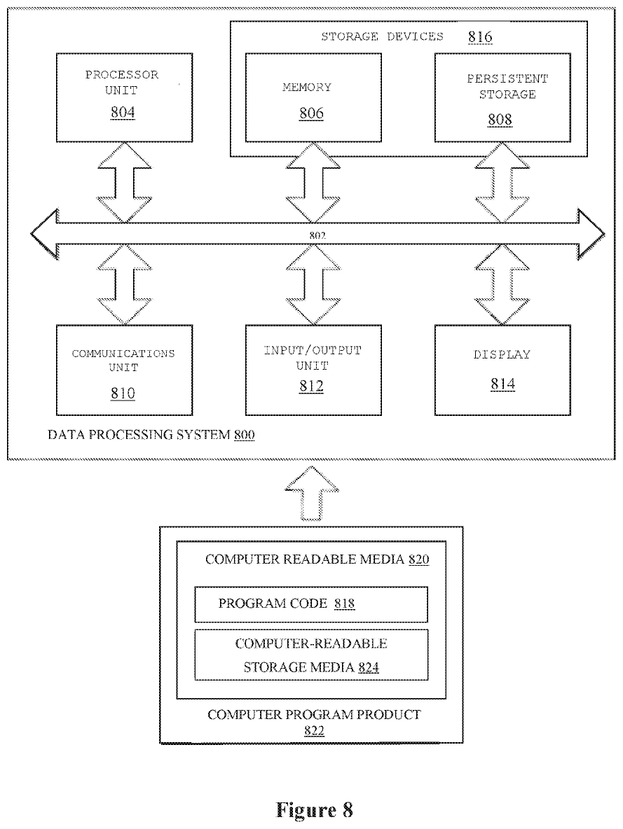

Turning now to FIG. 8, a block diagram of a data processing system is depicted in accordance with a representative example, whether physically localized or on the cloud. Data processing system 800 can be used to implement server computer 104, server computer 106, or one or more of client devices 110, in FIG. 1 or one or more of UEs 220 in FIG. 2. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. For example, processor unit 804 can may be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806 in these examples can be, for example, a random-access memory or any other suitable volatile or non-volatile storage device. Persistent storage 808 may take various forms, depending on particular implementations.

For example, persistent storage 808 may contain one or more components or devices. For example, persistent storage 808 can be a hard drive, a solid-state drive (SSD), a flash memory, a rewritable optical disk, a rewritable magnetic tape, or some combination thereof. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Display 814 provides a mechanism to display information to a user.

Instructions for at least one of the operating system, applications, or programs can be located in storage devices 816, which are in communication with processor unit 804 through communications framework 802. The processes of different examples can be performed by processor unit 804 using computer-implemented instructions, which may be located in a memory, such as memory 806.

These instructions are referred to as program code, computer usable program code, or computer-readable program code that can be read and executed by a processor in processor unit 804. The program code in the different examples can be embodied on different physical or computer-readable storage media, such as memory 806 or persistent storage 808.

Program code 818 is located in a functional form on computer-readable media 820 that is selectively removable and can be loaded onto or transferred to data processing system 800 for execution by processor unit 804. Program code 818 and computer-readable media 820 form computer program product 822 in these illustrative examples. In the illustrative example, computer-readable media 820 is computer-readable storage media 824.

In these illustrative examples, computer-readable storage media 824 is a physical or tangible storage device used to store program code 818 rather than a medium that propagates or transmits program code 818.

Computer-readable signal media may be, for example, a propagated data signal containing program code 818. For example, computer-readable signal media may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

Further, as used herein, “computer-readable media” can be singular or plural. For example, program code 818 can be located in computer-readable media 820 in the form of a single storage device or system. In another example, program code 818 can be located in computer-readable media 820 that is distributed in multiple data processing systems. In other words, some instructions in program code 818 can be located in one data processing system while other instructions in in program code 818 can be located in one data processing system. For example, a portion of program code 818 can be located in computer-readable media 820 in a server computer, while another portion of program code 818 can be located in computer-readable media 820 located in a set of client computers.

In an illustrative embodiment, a method for improving wireless service within a region separated from a wireless transmission point by a barrier that obstructs or degrades a wireless signal. The method includes receiving, at a first receiver, a millimeter wave signal, wherein the millimeter wave signal is a first signal. The first signal includes a wireless transmission protocol having a stack layer. The first receiver is disposed in a first region and the first region is disposed on a first side of a barrier. The method further includes converting the millimeter wave signal to at least one of an optical signal or an electrical signal, wherein the first signal is converted from the wireless transmission protocol to a conversion protocol. The conversion protocol preserves the first signal's stack layer. The method further includes transmitting the optical signal or the electrical signal on a conduit to a second receiver, wherein the second receiver is disposed in a second region and the second region is disposed on a second side of the barrier. The method further includes converting the optical or electrical signal from the conversion protocol back to the wireless transmission protocol. The method further includes transmitting the second converted signal to a wireless device, wherein the wireless device is disposed in a third region on the second side of the barrier.

In an illustrative embodiment, a computer program product for improving wireless service within a region separated from a wireless transmission point by a barrier that obstructs or degrades a wireless signal is provided. The computer program product includes a non-transitory computer-readable storage medium, storing program codes executed by a processor, to perform receiving, at a first receiver, a millimeter wave signal, wherein the millimeter wave signal is a first signal, the first signal comprises a wireless transmission protocol having a stack layer, the first receiver is disposed in a first region, and the first region is disposed on a first side of a barrier. The program codes executed by the processor further cause the processor to perform converting the millimeter wave signal to at least one of an optical signal or an electrical signal, wherein the first signal is converted from the wireless transmission protocol to a conversion protocol, and the conversion protocol preserves the first signal's stack layer. The program codes executed by the processor further cause the processor to perform transmitting the optical signal or the electrical signal on a conduit to a second receiver, wherein the second receiver is disposed in a second region and the second region is disposed on a second side of the barrier. The program codes executed by the processor further cause the processor to perform converting the optical or electrical signal from the conversion protocol back to the wireless transmission protocol. The program codes executed by the processor further cause the processor to perform transmitting the second converted signal to a wireless device, wherein the wireless device is disposed in a third region on the second side of the barrier.

In an illustrative embodiment, a system for improving wireless service within a region separated from a wireless transmission point by a barrier that obstructs or degrades a wireless signal is provided. The system includes a first receiver configured to receive a millimeter wave signal, wherein the millimeter wave signal is a first signal, the first signal comprises a wireless transmission protocol having a stack layer, the first receiver is disposed in a first region, and he first region is disposed on a first side of a barrier. The first system further includes a first converter communicably coupled to the first receiver, the converter configured to convert the millimeter wave signal to at least one of an optical signal or an electrical signal, wherein the first signal is converted from the wireless transmission protocol to a conversion protocol and the conversion protocol preserves the first signal's stack layer. The system further includes a first transmitter coupled to the converter. The system further includes a conduit communicably coupled to the first transmitter. The system further includes a second receiver communicably coupled to the conduit, wherein the conduit is configured to transmit the optical signal or the electrical signal to the second receiver, wherein the second receiver is disposed in a second region and the second region is disposed on a second side of the barrier. The system further includes a second converter communicably coupled to the second receiver and configured to convert the optical or electrical signal from the conversion protocol back to the wireless transmission protocol. The system further includes a transmitter communicably coupled to the second converter and configured to transmit the second converted signal to a wireless device, wherein the wireless device is disposed in a third region on the second side of the barrier.

Implementations may include one or more of the following features: wherein the barrier comprises an energy absorbing material; wherein the barrier comprises an obstacle occluding line-of-sight between the wireless device and a transmitter broadcasting the millimeter wave signal to the first receiver; wherein a distance between the wireless device and the second side of the barrier is less than a distance between the wireless device and the first side of the barrier; wherein the first receiver is a first transceiver and the second receiver is a second transceiver; wherein the wireless transmission protocol comprises a 3GPP protocol stack; and wherein the conversion protocol comprises a CPRI protocol stack.

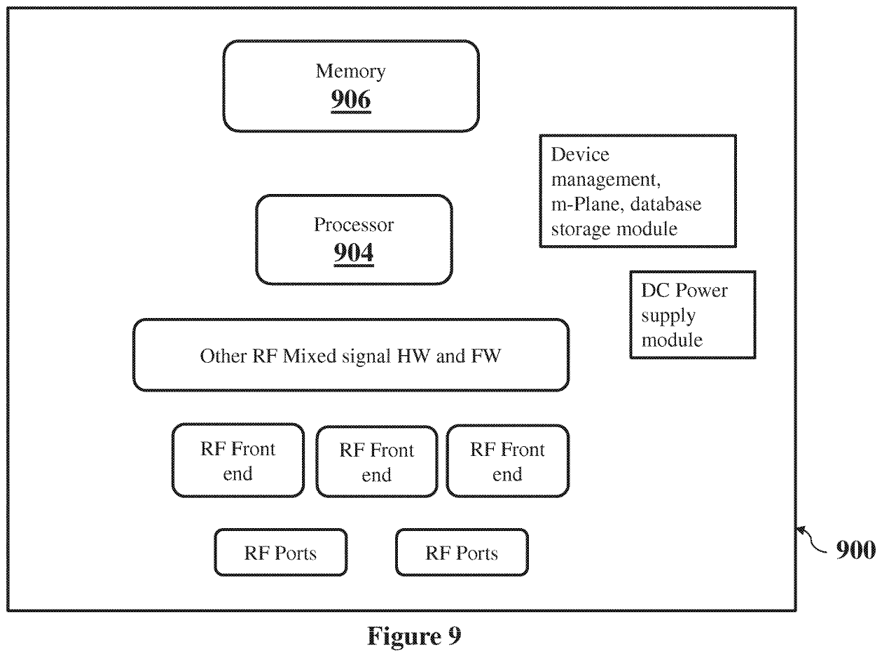

Different components illustrated for customer premise equipment regenerative device 900 are not meant to provide architectural limitations to the manner in which different examples can be implemented. In some illustrative examples, one or more of the components may be incorporated in or otherwise form a portion of another component. For example, memory 906, or portions thereof, may be incorporated in processor 904 in some representative aspects. Different illustrative examples can be implemented in a customer premise equipment regenerative device including components in addition to or in place of those illustrated for customer premise equipment regenerative device 900. Other components shown in FIG. 9 can be varied from the illustrative examples shown. The different examples can be implemented using any hardware device or system capable of running program code 818.

It is understood that any and all media, devices, and physical hardware components depicted in FIGS. 1-3 and 5-7 can be substituted by virtual devices deployable, in part or in whole, with a cloud-based implementation.

Descriptions of different illustrative examples has been presented for purposes of illustration and description, and are not intended to be exhaustive or limited to the examples in the form disclosed. The different illustrative examples describe components that perform actions or operations. In an illustrative example, a component can be configured to perform action or operation described. For example, a component can have a configuration or design for a structure that provides the component an ability to perform the action or operation that is described in the illustrative examples as being performed by the component.

Many modifications and variations will be apparent to those of ordinary skill in the art without departing from the scope and spirit of the described examples. Furthermore, different illustrative examples may provide different features as compared to other examples. The examples or examples selected are chosen and described in order to explain principles of the examples, practical application, and to enable others of ordinary skill in the art to understand the disclosure for various examples with various modifications as are suited to one or more particular contemplated uses. The terminology used herein was chosen to best explain the principles of the examples, the practical application or technical improvement over technologies found in the marketplace, or to enable others of ordinary skill in the art to understand the embodiments disclosed here.

The following description, together with FIGS. 9-14, sets forth subject matter that is added in this continuation-in-part application and that is not present in the parent application. As used herein, a “customer premise equipment (CPE) regenerative device” refers to a device, located at or within a customer premise, that receives a provider specific millimeter wave wireless signal and regenerates that signal across a barrier. The signal-regenerating systems and devices described above, including system 300, system 500, system 600, single device 608, and the data processing hardware described with respect to FIG. 9, are each an embodiment of a customer premise equipment regenerative device. Unlike a repeater, which merely amplifies and re-radiates a received radio frequency (RF) signal, the customer premise equipment regenerative device regenerates the signal. As used herein, “regenerating” means receiving the provider specific millimeter wave wireless signal, deconstructing the signal into a plurality of protocol stack layers (for example, the layers of a 3GPP protocol stack, optionally up to the packet data convergence protocol (PDCP) layer) of a conversion protocol that preserves the stack layer of the signal, transmitting the deconstructed signal across the barrier on a conduit, and reconstructing the provider specific millimeter wave wireless signal on the opposite side of the barrier. Because the customer premise equipment regenerative device deconstructs and reconstructs the signal rather than merely repeating it, the device has access to decoded RF condition data of the signal, which in turn enables placement of an agentic artificial intelligence (AI) module within the customer premise equipment regenerative device, as described below.

FIG. 9 is a block diagram of a customer premise equipment regenerative device 900 depicted in accordance with an illustrative example. Customer premise equipment regenerative device 900 includes a processor 904 and a memory 906. Customer premise equipment regenerative device 900 further includes one or more RF front ends coupled to one or more RF ports, the one or more RF front ends configured to receive and transmit millimeter wave wireless signals, a DC power supply module configured to provide electrical power to the device, a device management, m-Plane, and database storage module configured to manage the device and to store management plane (M-Plane) data, and other RF mixed-signal hardware and firmware. Processor 904 may be implemented in the manner described with respect to processor unit 804 of FIG. 8, and memory 906 may be implemented in the manner described with respect to memory 806 of FIG. 8. The device management, m-Plane, and database storage module provides a device management database that stores M-Plane data, as described in greater detail below. The agentic AI module described herein may be implemented as program code stored in memory 906 and executed by processor 904.

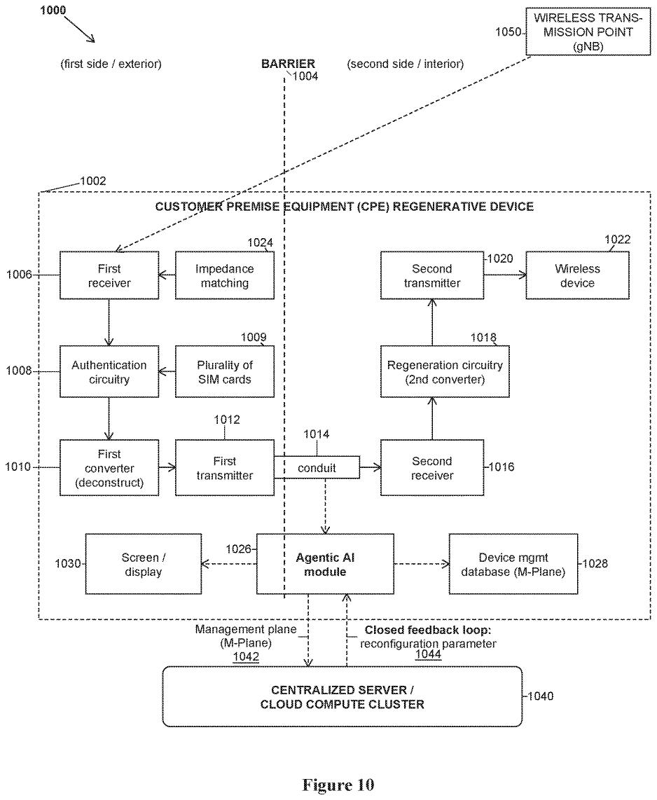

FIG. 10 is a block diagram of a system 1000 depicted in accordance with an illustrative embodiment. System 1000 includes a customer premise equipment regenerative device 1002 and a centralized server 1040. Customer premise equipment regenerative device 1002 is disposed with respect to a barrier 1004 that obstructs or degrades a wireless signal, such as a high energy efficient building material, a window pane, a window frame, or a door frame. Customer premise equipment regenerative device 1002 includes a first receiver 1006 disposed in a first region on a first side of barrier 1004 and configured to receive a millimeter wave signal broadcast by a wireless transmission point 1050, such as a gNB. An impedance matching circuit 1024 matches an input impedance of first receiver 1006 to receive only the millimeter wave signal and reject other radio signals. Authentication circuitry 1008, coupled to first receiver 1006, authenticates the millimeter wave signal to verify a specific wireless service provider using a plurality of SIM cards 1009. A first converter 1010 deconstructs the first signal into a plurality of protocol stack layers and converts the millimeter wave signal to at least one of an optical signal or an electrical signal in a conversion protocol, and a first transmitter 1012 transmits the converted signal on a conduit 1014 that crosses barrier 1004 to a second receiver 1016 disposed in a second region on a second side of barrier 1004. Regeneration circuitry 1018 converts the converted signal back to the wireless transmission protocol and regenerates a provider specific millimeter wave wireless signal, which a second transmitter 1020 transmits to a wireless device 1022 disposed on the second side of barrier 1004. Customer premise equipment regenerative device 1002 further includes an agentic AI module 1026, a device management database 1028, and a screen 1030. Agentic AI module 1026 collects RF condition data and location data and communicates with centralized server 1040 over a management plane 1042. Centralized server 1040 determines a reconfiguration parameter from the RF condition data and transmits the reconfiguration parameter to customer premise equipment regenerative device 1002 in a closed feedback loop 1044, whereby an RF parameter of customer premise equipment regenerative device 1002 is reconfigured.

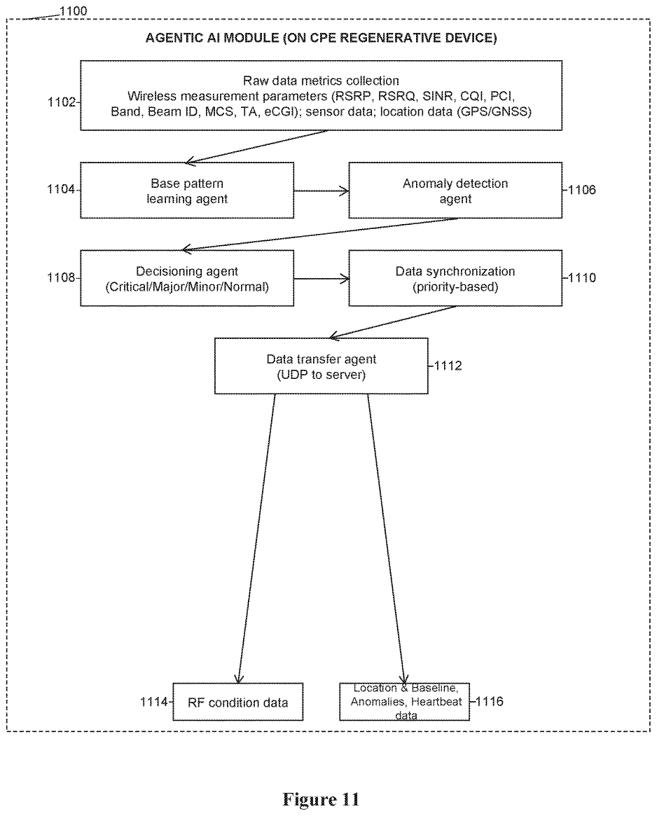

As used herein, an “agentic artificial intelligence (AI) module” refers to an autonomous, on-device agent, implemented in at least one of hardware or program code executed by a processor (for example, processor 904 of FIG. 9), that perceives a local environment by collecting metrics, reasons over the collected metrics by establishing baseline patterns and classifying deviations from the baseline patterns, and acts based on the reasoning by transferring data and by applying a reconfiguration to the device, in each case without requiring per-action human intervention. Agentic AI module 1026 may comprise a plurality of cooperating sub-agents, including, without limitation, a base pattern learning agent, an anomaly detection agent, a decisioning agent, a data synchronization agent, and a data transfer agent, as described with respect to FIG. 11. The agentic AI module obtains actionable intelligence on the customer premise equipment regenerative device and transmits the actionable intelligence to centralized server 1040 for further processing, where data from a large number (for example, millions) of geographically distributed customer premise equipment regenerative devices and external data such as weather, traffic, network utilization, congestion, and outages etc. may be collected and processed in real time or in near real time, configurable by a user.

FIG. 11 is a block diagram of an agentic AI module 1100 depicted in accordance with an illustrative embodiment. Agentic AI module 1100 is an example of agentic AI module 1026 of FIG. 10. Agentic AI module 1100 includes raw data metrics collection 1102, which collects wireless measurement parameters, sensor data, and location data. The wireless measurement parameters may include, without limitation, band information, a 5G new radio (NR) beam identifier, reference signal received power (RSRP), reference signal received quality (RSRQ), signal-to-interference-plus-noise ratio (SINR), channel quality indicator (CQI), physical cell identity (PCI), timing advance, physical resource block (PRB) utilization, modulation and coding scheme (MCS), carrier aggregation status, handover related parameters, an evolved cell global identity (eCGI) of a serving cell, and a ranking of a second-best serving cell and subsequent cell identities received at the customer premise equipment regenerative device from multiple wireless service providers. The sensor data may include, without limitation, location sensor data from a global positioning system (GPS) or global navigation satellite system (GNSS) receiver, accelerometer data, magnetometer data, temperature data, and device health sensor data regarding a processor, a memory, and a storage of the device. Agentic AI module 1100 further includes a base pattern learning agent 1104 that maintains a local baseline pattern and tracks real-time metrics; an anomaly detection agent 1106 that continuously monitors the metrics and flags real-time deviations from the local baseline pattern; a decisioning agent 1108 that automatically classifies a detected anomaly into one of a plurality of severity levels, including critical, major, minor, and normal; a data synchronization agent 1110 that performs a priority-based data synchronization strategy, transmitting a critical anomaly with substantially zero latency and performing periodic batching for data updates including regular telemetry data and non-critical baseline pattern variation; and a data transfer agent 1112 that securely transfers data to centralized server 1040, for example using a User Datagram Protocol (UDP) or similar protocol. As used herein, “RF condition data” 1114 refers to data describing a radio frequency condition decoded by the customer premise equipment regenerative device, and comprises at least one of a radio signal measurement, an interference measurement, or a set of available physical cell identities (PCIs), and may comprise any one or more of the wireless measurement parameters described above. As used herein, “location data” and the baseline data, anomalies, heartbeat, etc. 1116 refers to data describing a location of the customer premise equipment regenerative device, such as the GPS or GNSS location sensor data described above.

As used herein, a “management plane,” also referred to as an “M-Plane,” refers to a management and control channel, distinct from a user-plane data path that carries user traffic, over which the customer premise equipment regenerative device exchanges telemetry data and configuration data with centralized server 1040. The management plane may correspond to the control and management plane 418 of the CPRI protocol stack 404 of FIG. 4. The RF condition data and the location data transmitted over the management plane are stored as management plane (M-Plane) data in device management database 1028, which may be provided by the device management, m-Plane, and database storage module of FIG. 9. In an illustrative embodiment, traffic originating from the customer premise equipment regenerative device is treated as a separate network slice or virtual local area network (VLAN) having one or more quality of service (QoS) parameters. For example, traffic originating from the customer premise equipment regenerative device, including voice, data, video, or communication with an AI such as a prompt, prompt engineering, generative AI, or human-AI dialogue, may be assigned a specific network slice, VLAN, or QoS and sent to a specific destination, thereby reducing wireless bandwidth usage and spectrum utilization for end users and for communication service providers.

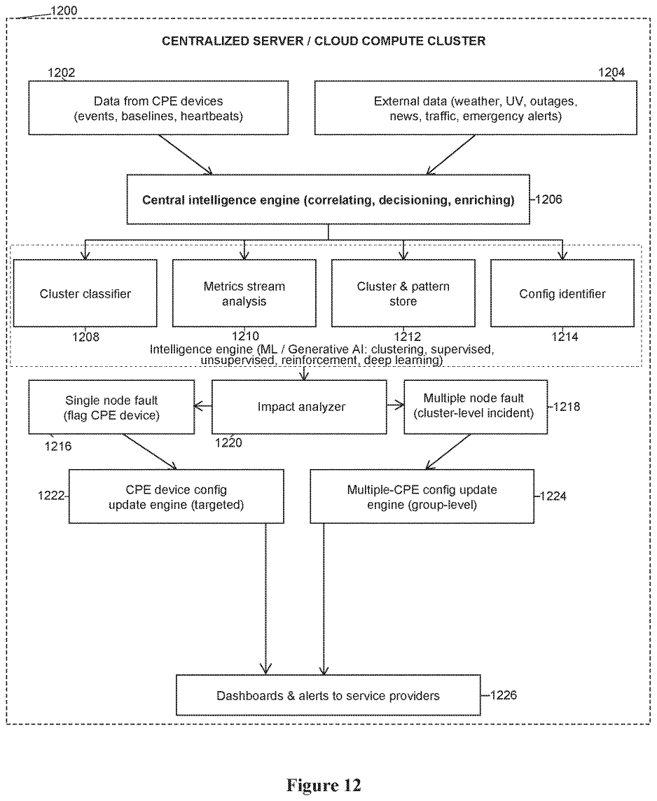

FIG. 12 is a block diagram of a centralized server 1200, also referred to as a cloud compute cluster, depicted in accordance with an illustrative embodiment. Centralized server 1200 is an example of centralized server 1040 of FIG. 10. Centralized server 1200 receives data 1202 from one or more customer premise equipment regenerative devices, including events, baselines, and heartbeats, and receives external data 1204, including at least one of weather, ultraviolet radiation, regional outages, news, traffic, an emergency alert, and radio utilization and performance data of network elements. A central intelligence engine 1206 correlates, makes decisions on, and enriches the received data. Centralized server 1200 includes an intelligence engine comprising a cluster classifier 1208 that groups similar devices, a metrics stream analysis 1210 that analyzes device data and external data, a cluster and pattern store 1212, and a config identifier 1214 that identifies a configuration using patterns identified from the metrics analysis. The intelligence engine performs multi-device telemetry analysis using one or more machine learning and generative AI algorithms, including, without limitation, clustering, pattern identification, supervised learning, unsupervised learning, reinforcement learning, and deep learning, and performs group classification, pattern recognition, model tuning, and automated anomaly detection. Centralized server 1200 further includes a single node fault block 1216 that identifies an abnormal customer premise equipment regenerative device and flags it for reporting, a multiple node fault block 1218 that classifies an incident at a cluster level and identifies affected clusters, and an impact analyzer 1220 that determines whether a specific customer premise equipment regenerative device or multiple devices are affected. A CPE device configuration update engine 1222 generates a targeted device configuration and pushes the configuration to a specific customer premise equipment regenerative device, and a multiple-CPE configuration update engine 1224 publishes group-level configuration updates. Centralized server 1200 generates dashboards and alerts 1226 for administrators and wireless service providers, providing operational oversight and predictive outage information.

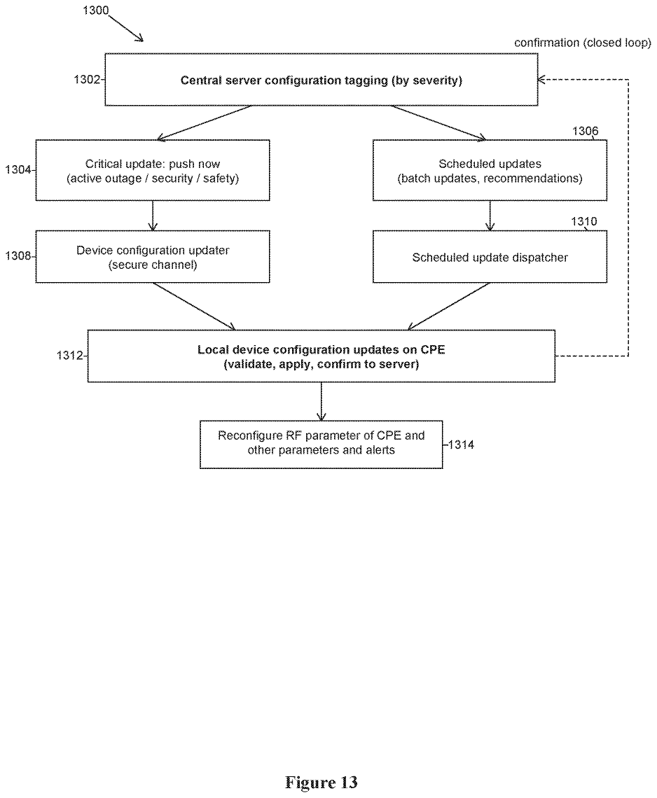

FIG. 13 is a block diagram showing a closed-loop configuration update 1300 between a customer premise equipment regenerative device and a centralized server depicted in accordance with an illustrative embodiment. A central server configuration tagging 1302 is an automated process that tags configuration updates based on severity. A critical update is handled by a push-now block 1304, for example for an active outage or a security or safety update, while a non-critical update is handled as a scheduled update 1306, for example a regular batch update or a recommendation. A device configuration updater 1308 delivers configuration updates through a secure communication channel, and a scheduled update dispatcher 1310 delivers regular configuration updates, software updates, and recommendations. The customer premise equipment regenerative device performs local device configuration updates 1312, in which the customer premise equipment regenerative device validates a configuration, applies the configuration, and confirms the update to the centralized server. Based on the applied configuration, the customer premise equipment regenerative device reconfigures parameters 1314. The confirmation of the update by the customer premise equipment regenerative device to the centralized server closes the feedback loop.

In operation, agentic AI module 1026 collects RF condition data decoded by customer premise equipment regenerative device 1002 and location data of customer premise equipment regenerative device 1002, and transmits the RF condition data and the location data to centralized server 1040 over management plane 1042. Centralized server 1040 processes the RF condition data, events, baselines, and heartbeats periodically in real time to select, for customer premise equipment regenerative device 1002, a signal having a minimum interference and a clean PCI, determines a reconfiguration parameter from the RF condition data, events, baselines, heartbeats, and external data and transmits the reconfiguration parameter to customer premise equipment regenerative device 1002 in closed feedback loop 1044. Customer premise equipment regenerative device 1002 reconfigures parameters based on the reconfiguration parameter. As used herein, a “clean PCI” refers to a physical cell identity that is free from PCI collision and PCI confusion with respect to neighboring cells and that exhibits an interference below a threshold. As used herein, a “reconfiguration parameter” refers to a parameter, determined by the centralized server from the RF condition data, events, baselines and heartbeats, and external data that specifies a change to a configuration of the customer premise equipment regenerative device, and an “RF parameter” and other parameters including algorithms, software, firmware, geographical external data such as weather, traffic data, network congestion, predicted outages and alerts refers to a configurable parameters of the customer premise equipment regenerative device that controls reception or transmission of an RF signal, including, without limitation, a selected serving cell or PCI, a selected beam, a gain, a selected frequency or band, or a receive filter setting. This closed-loop and feedback-loop action is advantageous in a high-rise building, where customer premise equipment regenerative device 1002 may receive several radio signals that interfere with one another, because reconfiguring the RF parameter based on the reconfiguration parameter reduces interference or redistributes traffic based on network service provider load among the plurality of radio signals received by the customer premise equipment regenerative device.

In an illustrative embodiment, authentication circuitry 1008 authenticates the millimeter wave signal using at least one subscriber identity module (SIM) card that is programmed to decode millimeter wave signals for the specific wireless service provider. The at least one SIM card may comprise a plurality of SIM cards 1009, each SIM card of the plurality of SIM cards corresponding to a different wireless service provider, and the authentication uses a SIM card of the plurality of SIM cards corresponding to the specific wireless service provider. In this manner, customer premise equipment regenerative device 1002 may authenticate and regenerate millimeter wave signals of multiple wireless service providers, with the specific wireless service provider of a received millimeter wave signal verified using the corresponding SIM card.

In an illustrative embodiment, centralized server 1040 obtains the location data from agentic AI module 1026 and determines location-based information from the location data. Centralized server 1040 transmits the location-based information to customer premise equipment regenerative device 1002 for display on screen 1030, which is attached to customer premise equipment regenerative device 1002. The location-based information may comprise at least one of local weather information, ultraviolet radiation information, local traffic information, local news, or an emergency alert. The location-based information may be displayed on screen 1030 together with radio resource management (RRM) information for the closed-loop feedback configuration described above.

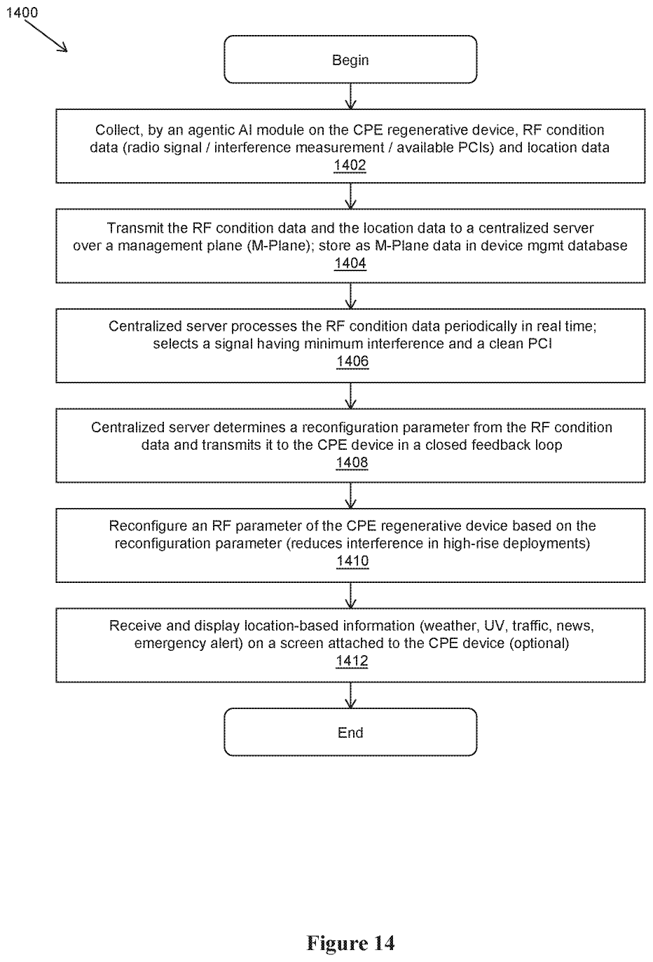

FIG. 14 is a flowchart of a method 1400 depicted in accordance with an illustrative embodiment. Method 1400 may be performed by customer premise equipment regenerative device 1002 and centralized server 1040 of FIG. 10. The method begins and, at block 1402, collects, by an agentic AI module executing on the customer premise equipment regenerative device, RF condition data, comprising at least one of a radio signal measurement, an interference measurement, or a set of available PCIs, and location data, events, baselines and heartbeats of the customer premise equipment regenerative device. At block 1404, the method transmits the RF condition data and the location data to a centralized server over a management plane and stores the RF condition data and the location data, events, baselines and heartbeats as M-Plane data in a device management database. At block 1406, the centralized server processes the RF condition data, events, baselines and heartbeats periodically in real time and selects a signal having a minimum interference and a clean PCI. At block 1408, the centralized server determines a reconfiguration parameter from the RF condition data, events, baselines and heartbeats and transmits the reconfiguration parameters to the customer premise equipment regenerative device in a closed feedback loop. At block 1410, the customer premise equipment regenerative device reconfigures an RF parameter based on the reconfiguration parameter, thereby reducing interference among a plurality of radio signals received by the customer premise equipment regenerative device in a high-rise building. At block 1412, the method optionally receives, from the centralized server, location-based information determined from the location data and displays the location-based information on a screen attached to the customer premise equipment regenerative device, the location-based information comprising at least one of local weather information, ultraviolet radiation information, local traffic information, local news, or an emergency alert. The method then ends.

Although the customer premise equipment regenerative device is described above primarily with respect to a 5G millimeter wave cellular signal, the device and the added features described herein are not limited thereto. In various embodiments, the millimeter wave signal is a signal of a 5G, a 6G, or any future generation of cellular and satellite technology. In other embodiments, the customer premise equipment regenerative device receives and regenerates a satellite communication signal, including, without limitation, a signal in a Ka band, a Ku band, or a V band used for satellite communications. Moreover, the added features described herein, including the agentic AI module and the closed-loop reconfiguration over the management plane, may also be applied to a copper customer premise equipment or a fiber optical customer premise equipment provided to a customer by an internet service provider (ISP).

In an illustrative embodiment, a method for improving wireless service within a region separated from a wireless transmission point by a barrier that obstructs or degrades a wireless signal comprises: receiving, at a first receiver of a customer premise equipment regenerative device, a millimeter wave signal that is a first signal comprising a wireless transmission protocol having a stack layer, the first receiver disposed in a first region on a first side of the barrier; authenticating the millimeter wave signal to verify a specific wireless service provider; converting the millimeter wave signal to at least one of an optical signal or an electrical signal by deconstructing the first signal into a plurality of protocol stack layers, thereby converting the first signal from the wireless transmission protocol to a conversion protocol that preserves the stack layer of the first signal and producing a converted signal in the conversion protocol; transmitting the converted signal on a conduit to a second receiver disposed on a second side of the barrier; converting the converted signal from the conversion protocol back to the wireless transmission protocol; regenerating a provider specific millimeter wave wireless signal and transmitting the provider specific millimeter wave wireless signal to a wireless device disposed on the second side of the barrier; collecting, by an agentic AI module executing on the customer premise equipment regenerative device, RF condition data decoded by the customer premise equipment regenerative device and location data of the customer premise equipment regenerative device, wherein the RF condition data comprises at least one of a radio signal measurement, an interference measurement, or a set of available PCIs; transmitting, by the agentic AI module, the RF condition data and the location data, events, baselines, and heartbeats to a centralized server over a management plane; and receiving, from the centralized server in a closed feedback loop, a reconfiguration parameter determined from the RF condition data, events, baselines, and heartbeats and reconfiguring parameters of the customer premise equipment regenerative device based on the reconfiguration parameters.

In an illustrative embodiment, a system comprises a customer premise equipment regenerative device and a centralized server. The customer premise equipment regenerative device comprises a first receiver programmed with at least one SIM card to decode a millimeter wave signal for a specific wireless service provider; authentication circuitry coupled to the first receiver and configured to authenticate the millimeter wave signal; a converter coupled to the authentication circuitry and configured to deconstruct the first signal into a plurality of protocol stack layers; a first transmitter; a conduit crossing the barrier; a second receiver; regeneration circuitry configured to convert the converted signal back to the wireless transmission protocol and to regenerate a provider specific millimeter wave wireless signal; a second transmitter configured to transmit the provider specific millimeter wave wireless signal to a wireless device; and an agentic AI module configured to collect RF condition data, sensor data and location data, AI module generates the base line patterns and detects the anomalies. The centralized server is communicably coupled to the customer premise equipment regenerative device over a management plane and is configured to receive the RF condition data and the location data, events, baselines, anomalies and heartbeats from the agentic AI module, determine a reconfiguration parameter from the RF condition data, events, baselines and heartbeats and external data such as weather, traffic, network congestion and location specific emergency alerts and transmit the reconfiguration parameters to the customer premise equipment regenerative device in a closed feedback loop to reconfigure parameters of the customer premise equipment regenerative device.

In an illustrative embodiment, a computer program product comprises a non-transitory computer-readable storage medium storing program code executable by a processor of a customer premise equipment regenerative device to perform operations comprising: authenticating, using at least one SIM card, a millimeter wave signal received at a first receiver of the customer premise equipment regenerative device to verify a specific wireless service provider; converting the first signal from the wireless transmission protocol to a conversion protocol that preserves the stack layer of the first signal by deconstructing the first signal into a plurality of protocol stack layers; regenerating, on a second side of the barrier, a provider specific millimeter wave wireless signal from the conversion protocol; collecting, by an agentic AI module, RF condition data and location data, events, baselines, anomalies, and heartbeats of the customer premise equipment regenerative device; transmitting the RF condition data and the location data to a centralized server over a management plane; receiving, from the centralized server in a closed feedback loop, a reconfiguration parameter determined from the RF condition data; and reconfiguring parameters of the customer premise equipment regenerative device based on the reconfiguration parameter.

The agentic AI module and the centralized server described herein may be implemented in software, hardware, or a combination of software and hardware. In an illustrative example, the agentic AI module is implemented as program code stored in a memory of the customer premise equipment regenerative device and executed by a processor of the customer premise equipment regenerative device, such as memory 906 and processor 904 of FIG. 9, and the centralized server is implemented using one or more data processing systems, such as data processing system 800 of FIG. 8, whether physically localized or deployed on a cloud. Any and all media, devices, and physical hardware components depicted in FIGS. 9-14 may be substituted by virtual devices deployable, in part or in whole, with a cloud-based implementation.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for improving wireless service within a region separated from a wireless transmission point by a barrier that obstructs or degrades a wireless signal, comprising:
receiving, at a first receiver of a customer premise equipment regenerative device, a millimeter wave signal, wherein:
the millimeter wave signal is a first signal;
the first signal comprises a wireless transmission protocol having a stack layer;
the first receiver is disposed in a first region; and
the first region is disposed on a first side of the barrier;
authenticating the millimeter wave signal to verify a specific wireless service provider;
converting the millimeter wave signal to at least one of an optical signal or an electrical signal by deconstructing the first signal into a plurality of protocol stack layers, thereby converting the first signal from the wireless transmission protocol to a conversion protocol that preserves the stack layer of the first signal and producing a converted signal in the conversion protocol;
transmitting the converted signal on a conduit to a second receiver disposed on a second side of the barrier;
converting the converted signal from the conversion protocol back to the wireless transmission protocol;
regenerating a provider specific millimeter wave wireless signal and transmitting the provider specific millimeter wave wireless signal to a wireless device disposed on the second side of the barrier;
collecting, by an agentic artificial intelligence (AI) module executing on the customer premise equipment regenerative device, radio frequency (RF) condition data decoded by the customer premise equipment regenerative device, location data of the customer premise equipment regenerative device, collected events data, heartbeats and generated baselines, anomalies wherein the RF condition data comprises at least one of a radio signal measurement, an interference measurement, or a set of available physical cell identities (PCIs);
transmitting, by the agentic AI module, the RF condition data and the location data, events, baselines, anomalies, and heartbeats to a centralized server over a management plane; and
receiving, from the centralized server in a closed feedback loop, a reconfiguration parameter determined from the RF condition data, events, baselines, anomalies, and heartbeats, and external data and reconfiguring RF parameters or update the software and/or firmware of the customer premise equipment regenerative device based on the reconfiguration parameters.

2. The method of claim 1, wherein the first region is disposed on the first side of the barrier, and the barrier comprises an energy absorbing material comprising at least one of a high energy efficient building material, a window pane, a window frame, or a door frame that obstructs the millimeter wave signal.

3. The method of claim 1, further comprising amplifying the millimeter wave signal after the authenticating, wherein the provider specific millimeter wave wireless signal exceeds an original wireless RF signal and includes network parameters enabling the wireless device to decode a Primary Synchronization Signal (PSS), a Secondary Synchronization Signal (SSS), an Evolved Cell Global Identity (eCGI), a Physical Cell Identity (PCI), and a Root Sequence Index (RSI) for authentication by a 5G millimeter wave radio network.

4. The method of claim 1, wherein the authenticating comprises authenticating the millimeter wave signal using at least one subscriber identity module (SIM) card that is programmed to decode millimeter wave signals for the specific wireless service provider, the at least one SIM card comprising a plurality of SIM cards each corresponding to a different wireless service provider, and the authenticating uses a SIM card of the plurality of SIM cards corresponding to the specific wireless service provider.

5. The method of claim 1, wherein the reconfiguration parameter is determined by the centralized server processing the RF condition data periodically in real time to select, for the customer premise equipment regenerative device, a signal having a minimum interference and a clean PCI, and reconfiguring the RF parameter reduces interference among a plurality of radio signals received by the customer premise equipment regenerative device in a high-rise building.

6. The method of claim 1, further comprising receiving, from the centralized server, location-based information determined from the location data, and displaying the location-based information on a screen attached to the customer premise equipment regenerative device, wherein the location-based information comprises at least one of local weather information, ultraviolet radiation information, local traffic information, local news, or an emergency alert.

7. The method of claim 1, wherein the wireless transmission protocol comprises a 3GPP protocol stack and the conversion protocol comprises a Common Public Radio Interface (CPRI) protocol stack, the deconstructing reverse converts the 3GPP protocol stack up to a packet data convergence protocol (PDCP) layer, and transmitting the RF condition data and the location data, events, baselines, anomalies, and heartbeats to the centralized server comprises transmitting management plane (M-Plane) data that is stored in a device management database.

8. A system for improving wireless service within a region separated from a wireless transmission point by a barrier that obstructs or degrades a wireless signal, the system comprising:
a customer premise equipment regenerative device comprising:
a first receiver programmed with at least one subscriber identity module (SIM) card to decode a millimeter wave signal for a specific wireless service provider, the first receiver configured to receive the millimeter wave signal as a first signal comprising a wireless transmission protocol having a stack layer, the first receiver disposed in a first region on a first side of the barrier, wherein the barrier comprises an energy absorbing material comprising at least one of a high energy efficient building material, a window pane, a window frame, or a door frame that obstructs the millimeter wave signal;
authentication circuitry coupled to the first receiver and configured to authenticate the millimeter wave signal to verify the specific wireless service provider;
a converter coupled to the authentication circuitry and configured to deconstruct the first signal into a plurality of protocol stack layers to convert the millimeter wave signal to at least one of an optical signal or an electrical signal, thereby converting the first signal from the wireless transmission protocol to a conversion protocol that preserves the stack layer of the first signal and producing a converted signal in the conversion protocol;
a first transmitter coupled to the converter and configured to transmit the converted signal;
a conduit coupled to the first transmitter and crossing the barrier;
a second receiver coupled to the conduit and disposed in a second region on a second side of the barrier;
regeneration circuitry coupled to the second receiver and configured to convert the converted signal from the conversion protocol back to the wireless transmission protocol and to regenerate a provider specific millimeter wave wireless signal that includes network parameters enabling a wireless device disposed on the second side of the barrier to decode a Primary Synchronization Signal (PSS), a Secondary Synchronization Signal (SSS), an Evolved Cell Global Identity (eCGI), a Physical Cell Identity (PCI), and a Root Sequence Index (RSI) for authentication by a 5G millimeter wave radio network;
a second transmitter coupled to the regeneration circuitry and configured to transmit the provider specific millimeter wave wireless signal to the wireless device; and
an agentic artificial intelligence (AI) module configured to collect radio frequency (RF) condition data decoded by the customer premise equipment regenerative device and location data events data, sensor data and generated baselines, anomalies, and heartbeats of the customer premise equipment regenerative device; and
a centralized server communicably coupled to the customer premise equipment regenerative device over a management plane and configured to:
receive the RF condition data and the location data, events, baselines, anomalies and heartbeats from the agentic AI module and external data;
determine a reconfiguration parameter from the RF condition data and other data from the AI module and external data; and
transmit the reconfiguration parameter to the customer premise equipment regenerative device in a closed feedback loop to reconfigure parameters of the customer premise equipment regenerative device.

9. The system of claim 8, wherein the at least one SIM card comprises a plurality of SIM cards, each SIM card of the plurality of SIM cards corresponding to a different wireless service provider, and the authentication circuitry is configured to authenticate the millimeter wave signal using a SIM card of the plurality of SIM cards corresponding to the specific wireless service provider.

10. The system of claim 8, wherein the centralized server is configured to process the RF condition data periodically in real time to select a signal having a minimum interference or network service provider resource utilization and a clean PCI, and the reconfiguration parameter configures the customer premise equipment regenerative device to use the selected signal.

11. The system of claim 8, wherein the customer premise equipment regenerative device further comprises a screen, and the centralized server is further configured to determine location-based information from the location data and to transmit the location-based information to the customer premise equipment regenerative device for display on the screen, wherein the location-based information comprises at least one of local weather information, ultraviolet radiation information, local traffic information, local news, or an emergency alert.

12. The system of claim 8, wherein the customer premise equipment regenerative device further comprises an impedance matching circuit configured to match an input impedance of the first receiver to receive only the millimeter wave signal and reject all other radio signals.

13. The system of claim 8, wherein the customer premise equipment regenerative device further comprises a device management database configured to store management plane (M-Plane) data comprising the RF condition data and the location data.

14. The system of claim 8, wherein the wireless transmission protocol comprises a 3GPP protocol stack and the conversion protocol comprises a Common Public Radio Interface (CPRI) protocol stack.

15. A computer program product for improving wireless service within a region separated from a wireless transmission point by a barrier that obstructs or degrades a wireless signal, the computer program product comprising a non-transitory computer-readable storage medium storing program code executable by a processor of a customer premise equipment regenerative device to perform operations comprising:
authenticating, using at least one subscriber identity module (SIM) card, a millimeter wave signal received at a first receiver of the customer premise equipment regenerative device to verify a specific wireless service provider, wherein the millimeter wave signal is a first signal comprising a wireless transmission protocol having a stack layer, and the first receiver is disposed on a first side of the barrier, the barrier comprising an energy absorbing material that obstructs the millimeter wave signal;
converting the first signal from the wireless transmission protocol to a conversion protocol that preserves the stack layer of the first signal by deconstructing the first signal into a plurality of protocol stack layers;
regenerating, on a second side of the barrier, a provider specific millimeter wave wireless signal from the conversion protocol, the provider specific millimeter wave wireless signal including network parameters enabling a wireless device to decode a Primary Synchronization Signal (PSS), a Secondary Synchronization Signal (SSS), an Evolved Cell Global Identity (eCGI), a Physical Cell Identity (PCI), and a Root Sequence Index (RSI) for authentication by a 5G millimeter wave radio network;
collecting, by an agentic artificial intelligence (AI) module, radio frequency (RF) condition data decoded by the customer premise equipment regenerative device and location data events, baselines, anomalies, and heartbeats of the customer premise equipment regenerative device, wherein the RF condition data comprises at least one of a radio signal measurement, an interference measurement, or a set of available physical cell identities (PCIs);
transmitting the RF condition data and the location data to a centralized server over a management plane;
receiving, from the centralized server in a closed feedback loop, a reconfiguration parameter determined from the RF condition data; and
reconfiguring parameters of the customer premise equipment regenerative device based on the reconfiguration parameter.

16. The computer program product of claim 15, wherein the at least one SIM card comprises a plurality of SIM cards, each SIM card of the plurality of SIM cards corresponding to a different wireless service provider, and the authenticating uses a SIM card of the plurality of SIM cards corresponding to the specific wireless service provider.

17. The computer program product of claim 15, wherein the operations further comprise receiving location-based information determined by the centralized server from the location data and outputting the location-based information for display on a screen attached to the customer premise equipment regenerative device, wherein the location-based information comprises at least one of local weather information, ultraviolet radiation information, local traffic information, local news, or an emergency alert.

18. The computer program product of claim 15, wherein the reconfiguration parameter is determined by the centralized server processing the RF condition data periodically in real time to select, for the customer premise equipment regenerative device, a signal having a minimum interference or service providers resource utilization and a clean PCI.

19. The computer program product of claim 15, wherein the operations further comprise storing, in a device management database, management plane (M-Plane) data comprising the RF condition data and the location data.

20. The computer program product of claim 15, wherein the wireless transmission protocol comprises a 3GPP protocol stack that is reverse converted up to a packet data convergence protocol (PDCP) layer, and the conversion protocol comprises a Common Public Radio Interface (CPRI) protocol stack.
